(19) United States
(12) Patent Application Publication
(10) Pub. No.: US 2015/0034278 A1
(43) Pub. Date: Feb. 5, 2015

(54) HEAT PIPE MATRIX FOR ELECTRONICS COOLING

(71) Applicant: Hamilton Sundstrand Corporation, Charlotte, NC (US)

(72) Inventors: William E. Rhoden, Glastonbury, CT (US); Leo J. Veilleux, JR., Wethersfield, CT (US)

(73) Assignee: Hamilton Sundstrand Corporation, Charlotte, NC (US)

(21) Appl. No.: 13/954,407

(22) Filed: Jul. 30, 2013

(51) Int. Cl. F28D 15/02; B23P 15/26

(52) U.S. Cl. CPC F28D 15/02; B23P 15/26
USPC 165/104.21; 29/890.032

(57) ABSTRACT

A heat pipe system and methods of arranging a heat pipe system are provided. The heat pipe system includes a plurality of heat pipes, with each of the plurality of heat pipes including a hot end thermally coupled to a heat source and a cold end thermally coupled to a heat sink The plurality of heat pipes include a first pair of heat pipes. When the plurality of heat pipes are secured to a rotatable body, the first pair of heat pipes are aligned with and oriented in opposing directions along a first axis of rotation of the rotatable body.

### FIELD OF THE DISCLOSURE

The present disclosure relates generally to heat pipe arrangements.

### BACKGROUND

Heat pipes (also sometimes referred to as “thermal pins”) are used to transfer heat from a heat source to a heat sink Heat pipes are generally constructed from an elongated, sealed tube that contains a thermal fluid in a partial vacuum. Typically, a wick is included in the sealed tube and defines a “vapor space” as a hollow region extending in the wick.

In operation, one end of the heat pipe is thermally coupled to the heat source, while the other end is thermally coupled to the heat sink Heat is drawn from the source and evaporates the thermal fluid at the first end. The vaporized thermal fluid progresses to the other axial end of the tube via the vapor space. At the other end, the heat from the thermal fluid is transferred to the heat sink, condensing the thermal fluid. The condensed thermal fluid then proceeds through the wick back to the first end, thereby starting the cycle again. In this way, the heat pipe serves to pump heat from the source to the sink via movement of the thermal fluid in the tube.

Such heat pipes are used in a variety of applications, including transferring heat in circuit boards. Typically, such circuit boards are generally stationary when being operated. However, in certain applications, the circuit boards may move relative to a stationary reference frame, such as, for example, in an aviation context.

### SUMMARY

Embodiments of the disclosure may provide a heat pipe system. The heat pipe system includes a plurality of heat pipes, with each of the plurality of heat pipes including a hot end thermally coupled to a heat source and a cold end thermally coupled to a heat sink The plurality of heat pipes includes a first pair of heat pipes. When the plurality of heat pipes are secured to a rotatable body, the first pair of heat pipes are aligned with and oriented in opposing directions along a first axis of rotation of the rotatable body.

Embodiments of the disclosure may further provide a method of arranging a heat pipe system. The method includes determining an orientation of a first primary flight axis and a second primary flight axis of an aircraft, and coupling heat pipes to one or more heat sources and one or more heat sinks, such that at least two of the heat pipes are aligned with and extend in opposite directions along the first primary flight axis and at least two of the heat pipes are aligned with and extend in opposite directions along the second primary flight axis.

Embodiments of the disclosure may further provide a method of arranging a heat pipe system. The method includes determining an orientation of a first axis of rotation and a second axis of rotation of a rotatable body. The method also includes coupling heat pipes to one or more heat sources and one or more heat sinks, such that at least two of the heat pipes are aligned with and extend in opposite directions along the first axis of rotation and at least two of the heat pipes are aligned with and extend in opposite directions along the second axis of rotation.

### BRIEF DESCRIPTION OF THE DRAWINGS

The accompanying drawing, which is incorporated in and constitutes a part of this specification, illustrates an embodiment of the present teachings and together with the description, serves to explain the principles of the present teachings. In the figures:

FIG. 1 illustrates a plan view of a heat pipe system, according to an embodiment.

FIG. 2 illustrates a perspective view of an aircraft employing the heat pipe system, according to an embodiment.

FIG. 3 illustrates a plan view of a heat pipe system with heat pipes offset on a substrate, according to an embodiment.

FIG. 4 illustrates a flowchart of a method for arranging heat pipes, according to an embodiment.

It should be noted that some details of the figure have been simplified and are drawn to facilitate understanding of the embodiments rather than to maintain strict structural accuracy, detail, and scale.

### DETAILED DESCRIPTION

Reference will now be made in detail to embodiments of the present teachings, examples of which are illustrated in the accompanying drawing. In the drawings, like reference numerals have been used throughout to designate identical elements, where convenient. In the following description, reference is made to the accompanying drawing that forms a part thereof, and in which is shown by way of illustration a specific exemplary embodiment in which the present teachings may be practiced. The following description is, therefore, merely exemplary.

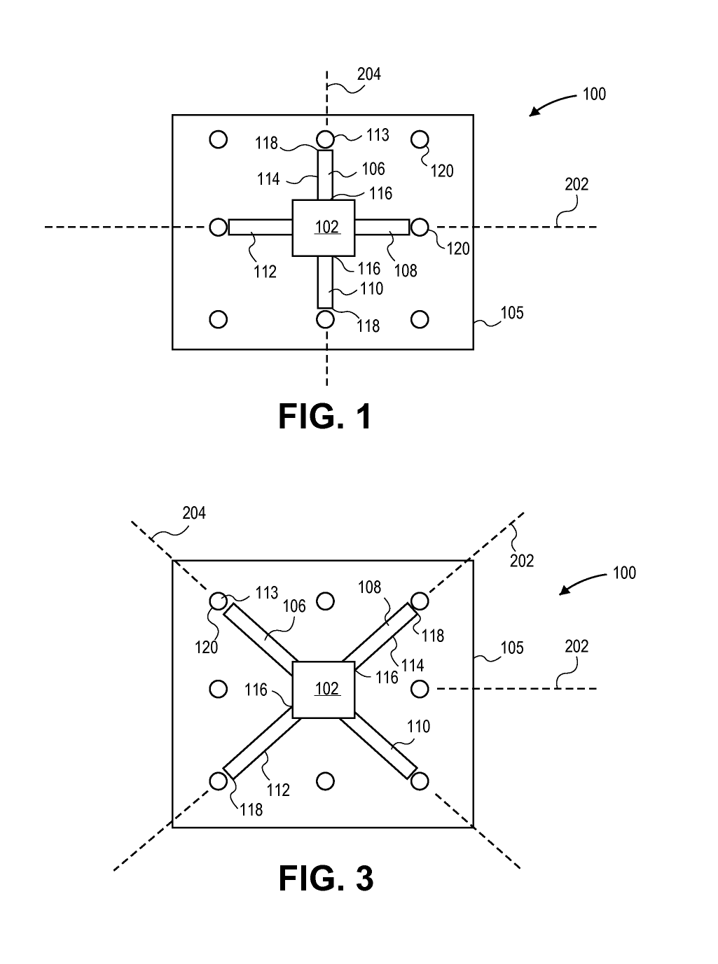

FIG. 1 illustrates a simplified plan view of a heat pipe system 100, according to an embodiment. The heat pipe system 100 generally includes at least one heat source 102, which may be any component (e.g., an electrical circuit component) that generates heat. Further, in at least one embodiment, the heat source 102 may be disposed on, in, and/or connected to a substrate 105, which may be a wiring or circuit board, such as a printed wiring or circuit board.

The system 100 may also include and a plurality of heat pipes 106, 108, 110, and 112, which may be coupled to and extend from the heat source 102 to one or more heat sinks 113. Any suitable heat pipe 106-112 design, whether having a wick or not, and may be employed by one of skill in the art consistent with the present disclosure. For ease of description, examples of component parts are referenced in FIG. 1 for heat pipe 106 and/or 108 only; however, it will be appreciated that each of the heat pipes 106-112 may have the same or similar constructions. Accordingly, in some embodiments, the heat pipes 106-112 may each include an elongate tube 114 that may extend on or in the substrate 105. Further, each of the heat pipes 106-112 may include a hot end 116 and a cold end 118. The hot end 116 may be thermally coupled with the heat source 102, so as to receive heat therefrom. The cold end 118 may be thermally coupled to the heat sink 113, so as to transfer heat thereto.

The heat sink 113 may be provided by one or more posts 120, as shown. In one example, an individual post 120 may be provided for each of the heat pipes 106-112. Further, the heat sink 113 (e.g., posts 120) may, for example, be thermally coupled with (e.g., disposed partially in) an area of high air flow, a fuel flow, etc. or otherwise configured to receive heat from the heat pipes 106-112. Further, the heat sink 113 may include or be connected with structures configured to enhance heat transfer, such as fins, pins, etc.

As shown, the heat pipes 106-112 may each extend radially outwards from the centrally-disposed heat sources 102. In certain applications, as will be described below, the pipes 106-120 may extend in accordance with a predetermined orientation of a rotatable body, the substrate 105, or both, such that one or more pairs of the heat pipes 106-112 may be aligned with one, two, or three axes of rotation, for example.

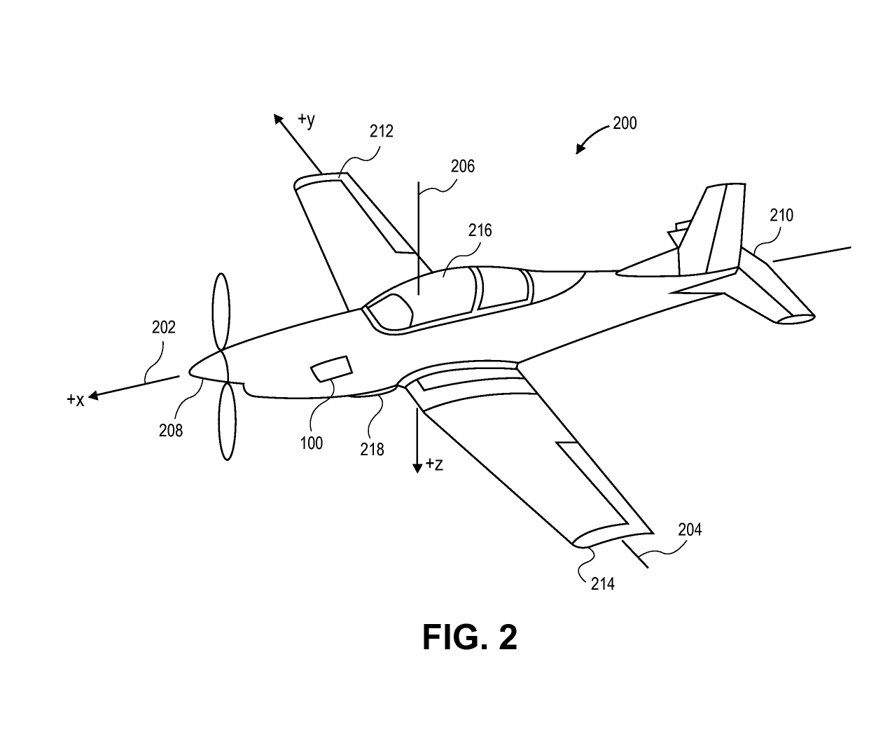

FIG. 2 illustrates a simplified perspective view of an aircraft 200, according to an embodiment. The aircraft 200 may be one example of a rotatable body, which may include two or more, e.g., three, axes of rotation 202, 204, 206 about which the body may rotate. In the example case of aviation, these axes of rotation 202, 204, 206 may be known as the primary flight axes. Thus, the first (or “x”) axis 202 may extend generally from the nose 208 of the aircraft 200 to the tail 210. Rotation about the x-axis 202 may be referred to as “roll.” The second (or “y” axis) 204 may extend from one wing tip 212 to the other 214, e.g., perpendicular to the x-axis 202. Rotation about the y-axis 204 may be referred to as “pitch.” The third (or “z”) axis 206 may extend from the top 216 of the aircraft 200 to the bottom 218, perpendicular to both the x-axis 202 and y-axis 204. Rotation about the z-axis 206 may be referred to as “yaw.”

The substrate 105 may be fixed to the aircraft 200 in any suitable location, whether in or on the aircraft 200, as schematically depicted in FIG. 2. Such fixing of the substrate 105 to the aircraft 200 may be accomplished using fasteners, adhesive, springs, dampers, movable couplings, or via any other suitable device and/or process. Further, the heat pipes 106-112 may be arranged such that pairs of heat pipes 106-112 are aligned with (i.e., substantially parallel to) one of the axes 202, 204, 206 on or in the substrate 105. Accordingly, for example, the substrate 105 of FIG. 1 may be oriented such that left-to-right is parallel to the x-axis 202 (FIG. 2) while top-to-bottom is aligned with the y-axis 204. As such, it will be appreciated that the pair of heat pipes 106, 108 is aligned with the y-axis 204, while the pair of heat pipes 108, 112 is aligned with the x-axis 202. Further, the component members of each pair of heat pipes 106, 110 and 108, 112 are oriented in opposing directions along the respective axis 202, 204. Thus, in the illustrated example, the hot ends 116 of heat pipes 106, 110 are closer together than their cold ends 118, and, in this example, the same is true of the heat pipes 108, 112.

In an example of operation, the heat pipes 106-112 may have a maximum heat transfer rate from the hot end 116 to the cold end 118 when the heat pipes 106-112 are disposed such that the hot end 116 is vertically below the cold end 118. The heat transfer rate may reduce as the heat pipes 106-112 are rotated away from this position to a “neutral point” where the heat pipes 106-112 are horizontal. The rate may further decease to a minimum when the heat pipes 106-112 are disposed such that the hot end 116 is above the cold end 118 (i.e., upside-down). This change in heat transfer rate, from maximum to neutral to minimum, may be related to the heat pipes 106-112 use of gravity to move the heavier liquid thermal fluid from the cold end 118 toward the hot end 116, thereby pushing the lighter gaseous thermal fluid from the cold end 118 toward the hot end 116.

Furthermore, in the heat pipe system 100, the heat pipes 106-112 may be sized and arranged such that heat transfer rate remains constant or increases, regardless of orientation of the aircraft 200. For example, neutral heat transfer rate may be defined with the substrate 105 at a generally horizontal (i.e., parallel to the ground) attitude. In this case, at horizontal, each of the heat pipes 106-120 operate in their neutral state.

However, if, as an illustrative example, the aircraft 200 rolls 90 degrees clockwise (looking at the front of the aircraft 200), the heat pipe system 100 may also roll 90 degrees, which may result in the heat pipe 106 being in its maximum transfer rate position, with the hot end 116 directly below the cold end 118. However, the heat pipe 110 may be in its minimum transfer rate position, with its hot end 116 above its cold end 118. The remaining two heat pipes 108, 112 coupled with the heat source 102 may continue operating at the neutral position. Accordingly, the additional heat transfer rate provided by the heat pipe 106 being in the maximum rate orientation may at least offset the loss to heat transfer rate caused by the heat pipe 110 being in the minimum rate orientation. As such, the heat pipes 106, 110 being aligned with the y-axis 204, and being oriented in reverse direction, may ensures that, during a roll, sufficient heat transfer rate is maintained.

As will be appreciated, a similar result may be provided with respect to the heat pipes 112, 108, which are similarly oriented parallel to, but in opposite directions, along the x-axis 202. Thus, if the aircraft 200 pitches up-or-down, one of the heat pipes 108, 112 may lose heat transfer rate, but the other one of the heat pipes 108, 112 may gain heat transfer rate. With appropriately-sized heat pipes 108, 112 selected, the loss of heat transfer rate may be at least offset by the gain, such that at least the same heat transfer rate that is provided with both the heat pipes 108, 112 are at their neutral positions is provided.

In some cases, the substrate 105 may not be aligned with the axes 202, 204, and/or 206 (FIG. 2), but may instead be angularly offset therefrom. In such cases, as shown in FIG. 3, the heat pipes 106-112 may be offset with respect to the substrate 105, so as to be aligned with one or more of the axes 202, 204, 206. As such, the heat pipes 106, 110 may be disposed parallel to and in opposite directions along the y-axis 204, while the heat pipes 108, 112 may be disposed parallel to and in opposite directions along the x-axis 202, despite the changed orientation of the substrate 105 with respect to the aircraft 200. Further, in some embodiments, one or more (for example, two) heat pipes may be disposed parallel to and in opposite directions to the z-axis, such that sufficient heat transfer rate may be provided despite yaw of the aircraft 200.

In some situations, a single heat pipe system 100 may include both the heat pipes 106-112 of FIG. 1 and those of FIG. 3. The heat pipes 106-113 of FIG. 3 may provide alignment with the flight axes 202, 204, 206 during compound attitude changes, such as, a combined pitch and roll. Moreover, the two configurations (which may be combined into a single configuration) are only two examples among many contemplated of arrangements of the heat pipes 106-112 in alignment with one or more of the primary flight axes 202, 204, 206.

Accordingly, when the heat pipe system 100 is fixed to the aircraft 200, the heat pipes 106-114 may be aligned the primary flight axes 202, 204, 206 at all or substantially all times, in at least one embodiment. Further, in situations where the axes 202, 204, 206 are perpendicular, the pairs of heat pipes 106-112 aligned therewith may also be perpendicular, or substantially perpendicular (i.e., perpendicular within a reasonable tolerance) to one another. It will be appreciated that the arrangement of the heat pipe system 100 with respect to the aircraft 200 may be predetermined, and the heat pipes 106-112 secured to the substrate 105, or otherwise thermally coupled with the heat source 102 and the heat sink 113, prior to securing the heat pipe system 100 into the aircraft 200.

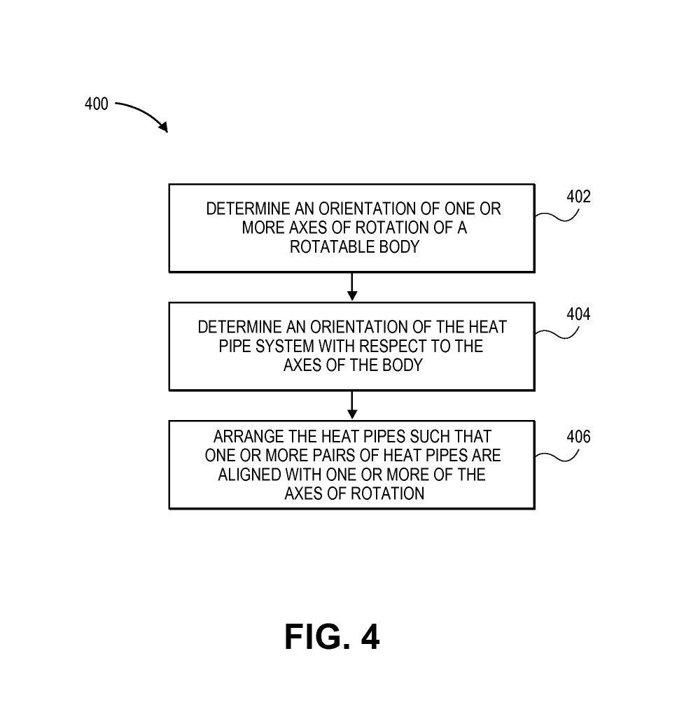

FIG. 4 illustrates a method 400 of arranging a heat pipe system, such as the heat pipe system 100, according to an embodiment. It will be appreciated that, while embodiments of the method 400 are described with reference to the heat pipe system 100, the method 400 may apply to any structure and is not to be considered limited to the structure of any of the various embodiments of the heat pipe system 100 described above.

The method 400 may begin by determining an orientation of a rotatable body, such as, for example, an aircraft 200, as at 402. Determining the orientation of the aircraft 200 may include determining at least first and second primary flight axes, which may be two of the primary flight axes of the aircraft 200, for example, the x, y, and z axes 202, 204, 206, with rotation about these axes being referred to as roll, pitch, and yaw, respectively. In at least one embodiment, determining the orientation at 402 may include determining the orientation of all three of the primary flight axes 202, 204, 206.

Before, during, or after determining at 402, in an embodiment, the method 400 may include determining an orientation of the heat pipe system 100 with respect to the axes of rotation (e.g., the primary flight axes 202, 204, 206), as at 404. For example, the orientation of the substrate 105 may determine the orientation of the system 100. Using the orientation of the heat pipe system 100 with respect to the axes, the method 400 may include arranging the heat pipes 106-112 of the heat pipe system 100 such that at least two of the heat pipes 106-112 are aligned with at least one of the axes of rotation 202, 204, and/or 206, as at 406.

In at least one embodiment, the heat pipes 106-112 may be coupled to a centrally-located heat source 102 and extend generally radially outward therefrom. Further, in various embodiments, pairs of heat pipes 106-112 may be provided, with each pair disposed along one of the axes of rotation (e.g., primary flight axes 202, 204, 206) and oriented in opposite directions, such that the hot ends 116 of the members of the pair are nearer together than are the cold ends 118. In at least one specific embodiment, two pairs of heat pipes 106-112 may be provided, extending generally outwards from the hot end 116 thermally coupled to the heat source 102 and proceeding outwards to the cold ends 118 thermally coupled to one or more heat sinks, which may be provided by posts 120.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications may be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A heat pipe system, comprising:
a plurality of heat pipes, each of the plurality of heat pipes comprising a hot end thermally coupled to a heat source and a cold end thermally coupled to a heat sink, the plurality of heat pipes comprising a first pair of heat pipes,
wherein, when the plurality of heat pipes are secured to a rotatable body, the first pair of heat pipes are aligned with and disposed in opposing directions along a first axis of rotation of the rotatable body.

2. The heat pipe system of claim 1, wherein:
the rotatable body defines a second axes of rotation; and
the plurality of heat pipes comprises a second pair of heat pipes, the second pair of heat pipes being aligned with the second axis of rotation and oriented in opposing directions along the second axis of rotation.

3. The heat pipe system of claim 2, wherein the first and second axes of rotation are perpendicular, such that the first pair of heat pipes are disposed substantially perpendicular to the second pair of heat pipes.

4. The heat pipe system of claim 2, wherein the rotatable body is an aircraft and rotation about the first axis is roll and rotation about the second axis is pitch.

5. The heat pipe system of claim 2, wherein:
the rotatable body defines a third axis of rotation; and
the plurality of heat pipes comprises a third pair of heat pipes that are aligned with the third axis of rotation.

6. The heat pipe system of claim 5, wherein rotation about the third axis of rotation is yaw.

7. The heat pipe system of claim 6, wherein the hot ends the first pair of heat pipes are disposed closer together than the cold ends of the first pair of heat pipes.

8. The heat pipe system of claim 1, wherein the heat source is centrally located and the plurality of heat pipes extend outward therefrom.

9. The heat pipe system of claim 1, further comprising a substrate, wherein the plurality of heat pipes, the heat sink, and the heat source are coupled to the substrate.

10. The heat pipe system of claim 9, wherein the plurality heat pipes are disposed in the substrate.

11. The heat pipe system of claim 1, wherein each of the plurality of heat pipes is configured to handle a full heat load of the heat source independently, at least when in an orientation of maximum heat transfer rate.

12. A method of arranging a heat pipe system, comprising:
determining an orientation of a first primary flight axis and a second primary flight axis of an aircraft; and
coupling heat pipes to one or more heat sources and one or more heat sinks, such that at least two of the heat pipes are aligned with and extend in opposite directions along the first primary flight axis and at least two of the heat pipes are aligned with and extend in opposite directions along the second primary flight axis.

13. The method of claim 12, further comprising disposing the heat pipes on or in a substrate, wherein the substrate is coupled with the heat source, the heat sink, or both.

14. The method of claim 13, further comprising determining an orientation of the substrate with respect to the first and second flight primary flight axes prior to coupling the heat pipes to the one or more heat sources and the one or more heat sinks.

15. The method of claim 12, further comprising determining an orientation of a third primary flight axis of the aircraft, wherein coupling the heat pipes comprises aligning at least two of the heat pipes with and in opposite directions along the third primary flight axis.

16. A method of arranging a heat pipe system, comprising:
determining an orientation of a first axis of rotation of a rotatable body; and
coupling heat pipes to one or more heat sources and one or more heat sinks, such that at least two of the heat pipes are aligned with and extend in opposite directions along the first axis of rotation.

17. The method of claim 16, further comprising:
determining an orientation of a second axis of rotation of the rotatable body, wherein coupling the heat pipes to the one or more heat sources and the one or more heat sinks comprises aligning at least two of the heat pipes with the second axis of rotation.

18. The method of claim 17, further comprising disposing the heat pipes on or in a substrate, wherein the substrate is coupled with the heat source, the heat sink, or both and is fixed to the rotatable body.

19. The method of claim 18, further comprising determining an orientation of the substrate with respect to the first and second axes prior to coupling the heat pipes to the one or more heat sources and the one or more heat sinks.

20. The method of claim 17, further comprising determining an orientation of a third axis of rotation of the rotatable body, wherein coupling the heat pipes comprises aligning at least two of the heat pipes with and in opposite directions along the third axis.
